(19) United States
(12) Patent Application Publication
(10) Pub. No.: US 2024/0417194 A1
(43) Pub. Date: Dec. 19, 2024

(54) UNLOADING STATION FOR A CONVEYOR FACILITY, CONVEYOR FACILITY COMPRISING SUCH AN UNLOADING STATION AND METHOD FOR AUTOMATED UNLOADING OF CONVEYING CONTAINERS

(71) Applicant: Dürkopp Fördertechnik GmbH, Bielefeld (DE)

(72) Inventors: Pascal REHM, Bielefeld (DE); Thomas JOHANNESMANN, Bielefeld (DE)

(21) Appl. No.: 18/673,034

(22) Filed: May 23, 2024

(30) Foreign Application Priority Data
Jun. 15, 2023 (DE) 10 2023 205 635.6

(51) Int. Cl. B65G 67/24

(52) U.S. Cl. CPC B65G 67/24; B65G 2201/0238

(57) ABSTRACT

An unloading station for a conveyor facility includes an overhead conveyor system including a conveyor rail deviating from the horizontal in an inclined section, a conveyor drive, and a plurality of overhead adapters for conveying along the conveyor rail via the conveyor drive. The station further includes a plurality of conveying containers, each container of which is conveyable in a suspended manner on one of the overhead adapters and includes an operable opener with which an underside of the conveying container is openable. The station also includes an opening unit for opening the conveying container. The opening unit is arranged along the inclined section at an opening position. A goods discharge surface is arranged below the conveyor rail for discharging goods discharged from the conveying containers. The goods discharge surface slopes downwards relative to the horizontal at the opening position.

### CROSS-REFERENCES TO RELATED APPLICATIONS

This application claims the priority, under 35 U.S.C. § 119, of German Patent Application Serial No. DE 10 2023 205 635.6, filed Jun. 15, 2023, the content of which is incorporated herein by reference in its entirety as if fully set forth herein.

### FIELD

The disclosure relates to an unloading station for a conveyor facility, a conveyor facility comprising such an unloading station and a method for the automated unloading of conveying containers in such a conveyor facility.

### BACKGROUND

DE 10 2018 201 676 A1 discloses conveying containers that are transported in a suspended manner. The conveying containers can be opened in an automated manner on their underside. openable. In an open state, a carrying volume of the conveying container is released downwards, so that items conveyed by the conveying container are automatically discharged from the conveying container, in particular by gravity. The discharge of the items is uncomplicated but uncontrolled.

### SUMMARY

It is an object of the disclosure to improve the unloading of such conveying containers.

This object is achieved by an unloading station for a conveyor facility comprising an overhead conveyor system with a conveyor rail which deviates from the horizontal in an inclined section a conveyor drive and a plurality of overhead adapters conveyed along the conveyor rail by means of the conveyor drive, a plurality of conveying containers, each of which are conveyable in a suspended manner on one of the overhead adapters, comprise an operable opening mechanism with which an underside of the conveying container is openable, an opening unit for opening the conveying container, wherein the opening unit is arranged along the inclined section at an opening position, a goods discharge surface arranged below the conveyor rail for discharging goods discharged from the conveying containers, wherein the goods discharge surface slopes downwards relative to the horizontal at the opening position, by a conveyor facility comprising the unloading station described above and a horizontal conveyor, which in particular adjoins the goods discharge surface in terms of conveying technology and by a method for the automated unloading of conveying containers in a conveyor facility, comprising the method steps of suspended conveying of conveying containers by means of overhead adapters along a conveyor rail which slopes downwards at least in sections relative to the horizontal, opening of at least one conveying container at an opening position by means of an opening unit, gravity-induced discharge of the goods from the conveying containers onto a goods discharge surface arranged below the conveyor rail, which goods discharge surface slopes downwards relative to the horizontal at the opening position.

In particular, the goods are discharged from overhead conveying containers directly onto a goods discharge surface. In particular, the goods slide out of the conveying containers downwards due to gravity after the conveying containers have been opened, in particular in an automated manner, by means of an opening unit. In particular, the opening unit enables the conveying containers to be opened as they move. The conveying containers are opened “in passing”. In particular, it is not necessary to stop the conveying containers to open them. In particular, the opening process and the resulting unloading of the goods takes place continuously. At an opening position, the goods discharge surface slopes downwards in relation to the horizontal. The goods discharged onto the goods discharge surface can be conveyed away from the goods discharge surface, in particular by gravity. In particular, the goods discharge surface is inclined downwards or has a downward curvature. The curvature can be designed to be progressive or degressive.

In particular, the drop height for the discharged goods from the conveying containers is reduced. The discharge of the goods is particularly gentle and damage to the goods is avoided.

In particular, it has been recognized that the goods are discharged from the conveying containers onto the goods discharge surface in a controlled manner. The identity of the goods remains known even after they have been discharged from the conveying container onto the goods discharge surface. In particular, the order of the discharged goods is prevented from changing as a result of uncontrolled discharge. The unloading station enables, in particular, automated and, in particular, fully automated discharge of the goods from the conveying containers, in particular to other conveying systems and/or into transport containers, in particular to horizontal conveying containers. In particular, the unloading station enables an increased unloading capacity, which in particular is at least 1,000 goods per hour.

The unloading station has an overhead conveyor system with a conveyor rail that deviates from the horizontal in an inclined section. For this purpose, the conveyor rail is inclined relative to the horizontal in a linear section and/or curved relative to the horizontal in a curved section. The curved section can be progressive or degressive. The opening position is fixed along the conveyor rail. The opening unit is arranged at the opening position. In particular, the opening unit is arranged adjacent to the conveyor rail and, in particular, is attached to the conveyor rail. The opening unit enables the conveying containers conveyed along the conveyor rail to be opened. The overhead conveyor system has a conveyor drive by means of which overhead adapters are conveyed along the conveyor rail. In particular, the overhead adapters are conveyed at a defined and, in particular, variably adjustable conveying speed.

The conveying containers are designed in particular in accordance with DE 10 2018 201 676 A1, to which express reference is hereby made. The conveying containers are in particular overhead conveyor bags, each of which can be conveyed in a suspended manner on one of the overhead adapters. The conveying containers have an opening mechanism that can be actuated by the opening unit in order to open an underside of the conveying container, in particular in an automated manner. As a result, a carrying volume defined by the conveying container is released downwards in the open state, so that goods can be discharged downwards from the conveying containers automatically, in particular by gravity. The fact that the goods discharge surface slopes downwards in relation to the horizontal at the opening position means that the goods are advantageously received at the goods discharge surface and transported away.

In particular, it has been recognized that the goods conveyed in the conveying containers are discharged from the conveying containers at a discharge speed which, in particular, is essentially independent of the size and weight of the goods. The discharge speed is essentially the same for all goods. The unloading process is procedurally robust and, in particular, advantageously automatable.

In particular, it has been recognized that the goods are advantageously reoriented in their spatial position at the unloading station by means of the goods discharge surface, in particular from a predominantly vertical orientation in the conveying containers to a predominantly horizontal orientation in a subsequent conveyor system and/or in transport containers. The horizontal orientation is particularly advantageous for the automated further processing of the discharged goods.

An unloading station in which the goods discharge surface is designed to be inclined downwards at the opening position with respect to the horizontal at a first angle of inclination, wherein n₁≥45°, enables the goods to be advantageously received at the goods discharge surface. The first angle of inclination is understood to be the negative slope of the goods discharge surface at the opening position. If the goods discharge surface is inclined downwards at the opening position, a linear inclination section is formed there. In the case of a curved design of the goods discharge surface at the opening position, the first angle of inclination is to be understood as a tangent at the opening position. The first angle of inclination is at least 45°, in particular at least 60°, in particular at least 750 and in particular at least 80°. In order to nevertheless ensure that the discharged goods rest firmly on the goods discharge surface, it is advantageous if the first angle of inclination is less than 90° and in particular is at most 80° and in particular at most 85°.

It has been recognized that the steeper the goods discharge surface is inclined downwards at the opening position, the more stable the receipt of the goods is. The subsequent reorientation of the spatial position of the goods can be carried out easily if the goods discharge surface is suitably designed.

An unloading station in which the goods discharge surface is arranged at a vertical distance below the conveyor rail in such a manner that the conveying containers touch the goods discharge surface in the unopened state enables a particularly gentle discharge of the goods from the conveying containers. In particular, the goods can slide directly from the respective conveying container onto the goods discharge surface arranged below. The drop height is minimized. The impulse acting on the goods when they hit the goods discharge surface is minimized. In particular, the conveying containers touch the goods discharge surface in the unopened state, in particular upstream of the opening position.

It has been recognized that the discharge of the goods is also improved by the fact that undesired oscillation of the conveying containers is minimized and, in particular, prevented by the contact of the conveying containers with the goods discharge surface. The conveying containers are stabilized by the contact with the goods discharge surface. This also improves the discharge of the goods. The risk of uncontrolled discharge of goods is minimized. It is advantageous if the conveying containers are designed with closing strips on their underside, which are made in particular from a material that has an inherent rigidity. The closing strips are designed to be stable. The closing strips allow the respective conveying container to rest against the goods discharge surface like a line. The transport of the conveying containers along the goods discharge surface is thus additionally stabilized.

Alternatively, it is also possible for the vertical distance to be dimensioned in such a manner that the conveying containers are arranged vertically spaced from, i.e. without contact to, the goods discharge surface in the unopened state. Due to the vertical spacing, the conveying containers can be conveyed along the goods discharge surface without friction. The vertical spacing is particularly small in such a manner that oscillation of the conveying containers along the conveying direction is essentially prevented if the conveying containers touch the goods discharge surface even at small oscillation angles when travelling backwards against the conveying direction. In this case, undesired oscillation is reliably prevented—despite the conveying container being arranged in a non-contacting position in relation to the goods discharge surface in an oscillation-free state. A small oscillation angle is in particular at most 5°, in particular at most 3° and in particular at most 1° in relation to an oscillation axis, which is defined in particular by the rolling axis of the support rollers of the overhead adapter.

When the goods are discharged as described hereinafter, the accuracy is additionally improved. Along a parallel section of the conveyor rail, the vertical distance between the conveyor rail and the goods discharge surface is constant. It is advantageous if the conveyor rail runs linearly along the parallel section. A curved course along the parallel section for the conveyor rail and goods discharge surface is also possible. The opening position is arranged in particular within the parallel section.

In addition or as an alternative to the parallel section, the conveyor rail can have an approach section. Along the approach section, the vertical distance of the conveyor rail with respect to the goods discharge surface is reduced, in particular reduced linearly. The reduction can also be non-linear, in particular progressive or degressive. It has been found that this improves the alignment of the conveying containers with respect to the goods discharge surface. In particular, the alignment of the conveying containers with respect to the goods discharge surface can be forced. The reduction of the vertical distance along the approach section is at most 15%, in particular at most 10%, in particular at most 5% and in particular at most 3%.

The embodiment of the goods discharge surface designed statically as a sliding surface is particularly uncomplicated. In particular, the goods discharge surface has no moving parts. In particular, the goods discharge surface has a sliding surface arranged at the top. The goods discharge surface is designed in particular as a slide and may in particular have a suitable plastic covering on its surface. The plastic covering can be arranged on a carrier material, which is in particular a metal sheet and in particular a steel sheet. The plastic covering is in particular made of thermoplastic material and in particular polyethylene and in particular ultra-high molecular weight polyethylene, in particular PE-1000. The plastic material has a high tear and wear resistance, good sliding properties, high durability, is temperature-resistant and enables good noise damping.

A transfer section which is arranged to be inclined at a second angle of inclination relative to the horizontal, wherein n₂<n₁, and/or which is designed to be curved at least in sections, enables uncomplicated and direct transfer of the goods from the goods discharge surface to a downstream conveyor system and/or into transport containers. The goods are transferred, in particular gently, into the predominantly horizontal orientation and delivered to a downstream conveyor system or transport container. The spatial reorientation of the goods is implemented in a mechanically robust manner. In particular, the goods follow a steady and continuous conveyor path. The risk of an uncontrolled and undesired change in position of the goods is minimized and, in particular, excluded. Continuous further transport of the delivered goods is guaranteed. The transfer section is arranged to be inclined relative to the horizontal, in particular at a second angle of inclination, which is in particular smaller than the first angle of inclination of the goods discharge surface at the opening position. The second angle of inclination is in particular at most 10°, in particular at most 5°, in particular at most 1°. It is also conceivable that the transfer section is arranged parallel to the horizontal. The transfer section can additionally or alternatively also be designed to be curved, at least in sections.

The goods discharge surface which has a downward conveyor, in particular a cleated belt or a conveyor belt with stopping members and/or with an adhesive surface, enables active conveyance of the goods in addition to the gravity-induced downhill force. The goods can be conveyed lying directly on a downward conveyor and/or in separate horizontal conveying containers into which the goods are discharged. The downward conveyor enables active downward conveyance of the discharged goods along the goods discharge surface. The goods discharged from the conveying containers are actively removed from the conveying containers by means of the downward conveyor. This reduces the risk of unintentional jamming or snagging of the goods on the conveying containers. The discharge of the goods is therefore particularly robust.

The downward conveyor which has a drive with a variably adjustable conveying speed enables increased flexibility in the discharge of goods. In particular, a differential speed between the downward conveyor and the conveying containers of the overhead conveyor system can be set in order to improve the discharge of the goods from the conveying containers. In particular, the differential speed is set so that the speed of the downward conveyor is greater than the speed of the conveying containers, wherein the speed of the downward conveyor is at most 20% greater than the speed of the conveying containers, at most 15%, at most 10% and in particular at most 5%.

The embodiment of the opening unit which is designed to be switchable in such a manner that the opening unit opens a conveying container arranged at the opening position or allows it to pass unopened depending on a control signal enables goods to be discharged in a targeted manner. In particular, this makes it possible for goods not to be discharged in a targeted manner and for the conveying containers to be conveyed past the opening position in the unopened state. The switchable opening unit is in signal communication in particular with a control unit. The control unit transmits a control signal to the opening unit. Depending on the control signal, the conveying containers located at the opening position are opened or pass the opening position unopened.

An unloading station in which a side guide for the conveying containers is arranged at the goods discharge surface enables increased reliability when discharging goods. A lateral guide, in particular in the form of lateral guiding webs at the goods discharge surface, ensures lateral stabilization of the conveying containers. Undesired lateral oscillation of the conveying containers is prevented.

An unloading station in which the inclined section slopes downwards in relation to the horizontal enables an advantageous discharge of goods. In particular, the unloading station can be operated at a high goods throughput. Due to the fact that the conveyor rail in the inclined section slopes downwards in relation to the horizontal, the distance between two conveying containers arranged one behind the other in the conveying direction can be reduced. The conveying containers are conveyed with a comparatively high density. In particular, the conveyor rail is inclined downwards relative to the horizontal in the linear section and/or curved downwards relative to the horizontal in the curved section.

Alternatively, it is possible for the inclined section to be designed to be inclined upwards and/or curved upwards along the conveying direction of the conveyor drive. The conveying direction of the discharged goods along the goods discharge surface has, in particular, a horizontal component that is orientated essentially opposite a horizontal component of the conveying direction of the conveying containers.

A conveyor facility comprising the unloading station described above and a horizontal conveyor, which in particular adjoins the goods discharge surface in terms of conveying technology, essentially has the advantages of the unloading station, reference to which is hereby made. With such a conveyor facility, goods which have previously been conveyed in a suspended manner in conveying containers, in particular individually, using an overhead conveyor system, can subsequently be conveyed further by means of a horizontal conveyor and in particular in horizontal conveying containers, and in particular processed further. In particular, such a conveyor facility enables automated and, in particular, fully automated handling and processing of the goods. The conveyor facility is in particular an overhead conveyor facility.

A method for the automated unloading of conveying containers in a conveyor facility, comprising the method steps of suspended conveying of conveying containers by means of overhead adapters along a conveyor rail which slopes downwards at least in sections relative to the horizontal, opening of at least one conveying container at an opening position by means of an opening unit, gravity-induced discharge of the goods from the conveying containers onto a goods discharge surface arranged below the conveyor rail, which goods discharge surface slopes downwards relative to the horizontal at the opening position, enables the advantages of the unloading station according to claim 1, reference to which is hereby made.

A method in which the conveying containers are guided to abut against the goods discharge surface upstream of the opening position ensures stable unloading of the goods. The conveying containers are guided in particular on their underside and/or laterally at the goods discharge surface, in particular by contact at the goods discharge surface and/or at a lateral guide.

Switched opening in which the conveying containers are opened in dependence on the conveyed goods enables a targeted and automated unloading process. In particular, the control signal required for this is provided by a control unit. The control unit generates the control signal in particular on the basis of the identification data of the conveying containers, which have been captured in particular by means of an identification device arranged along the conveying system. Machine-readable codes, in particular barcodes, QR codes or transponder readers that can read RFID data carriers, are used for identification. The machine-readable codes are arranged on and/or integrated into the overhead adapters in particular.

Both the features specified in the patent claims and the features specified in the following exemplary embodiment of a conveyor facility are each suitable, either on their own or in combination with one another, for further embodying the subject matter of the disclosure. The respective combinations of features do not represent any restriction with regard to the further embodiments of the subject matter of the disclosure, but are essentially merely exemplary in character.

Further features, advantages and details of the disclosure are apparent from the following description of an exemplary embodiment with reference to the drawing.

### BRIEF DESCRIPTION OF THE DRAWINGS

FIG. 1 shows a schematic representation of a conveyor facility,

FIG. 2 shows a perspective view of a conveying container of the conveyor facility in FIG. 1,

FIG. 3 shows a perspective view of an unloading station for the conveying containers according to FIG. 2.

### DETAILED DESCRIPTION

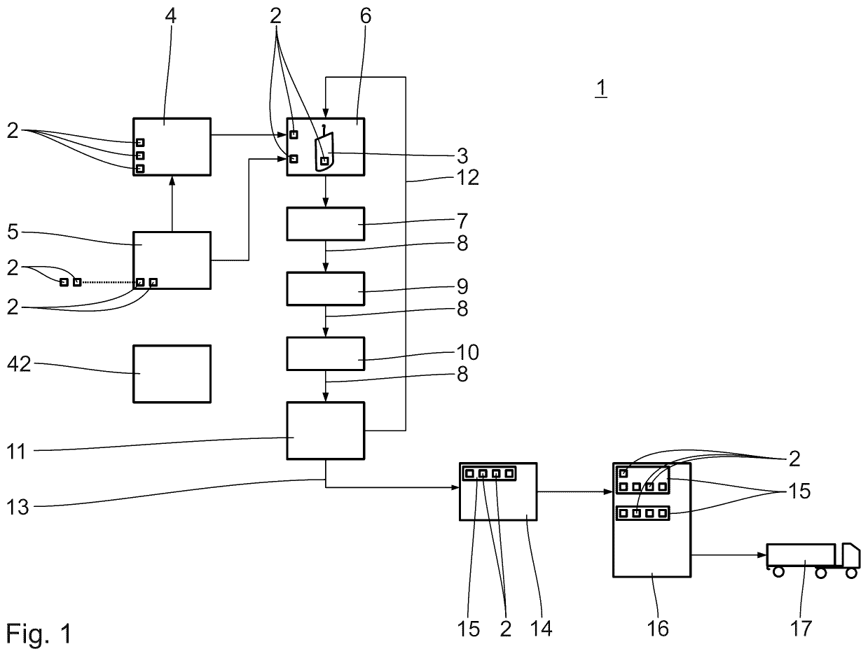

A conveyor facility labelled 1 as a whole in FIG. 1 is an overhead conveyor facility and is used for conveying and/or transporting goods 2. The goods 2 are conveyed in the conveyor facility 1, in particular individually, in conveying containers 3 in a suspended manner.

The goods 2 are, for example, items of clothing packed in bags or goods packed in other transport containers, in particular cardboard boxes, for example from the online retail sector, also known as e-commerce.

The conveyor facility 1 comprises a goods stock 4 in which the goods 2 are stored. The goods stock 4 can be designed as a manual stock or as an automatic stock. The conveyor facility 1 also has an incoming goods zone 5, at which the goods 2 are fed to the conveyor facility 1, in particular from outside. Returned goods can also be fed to the incoming goods zone 5. In terms of conveying technology, the incoming goods zone 5 is connected to the goods stock 4. The connection in terms of conveying technology is, for example, a conveyor belt or a manual feed of the goods 2, which may in particular also be present in containers in the incoming goods zone 5, to the goods stock 4.

The conveyor facility 1 also comprises a loading station 6, at which the goods 2 are loaded into the conveying containers 3. The loading station 6 is connected to both the goods stock 4 and the incoming goods zone 5 independently in terms of conveying technology. By means of the connection in terms of conveying technology, the goods 2 can be conveyed from the goods stock 4 and/or from the incoming goods zone 5 to the loading station 6. The goods 2 can also be conveyed manually from the goods stock 4 and/or from the incoming goods zone 5 to the loading station 6.

The conveyor facility 1 comprises an apparatus 7 for feeding the loaded conveying containers 3 into an overhead conveyor system 8. The apparatus 7 is connected to the overhead conveyor system 8 in terms of conveying technology and is connected thereto. The overhead conveyor system 8 is part of the conveyor facility 1.

The conveyor facility 1 comprises a goods storage unit 9, which is designed in particular as a circulating storage unit and is used in particular for intermediate storage of the loaded conveying containers 3.

The conveyor facility 1 also has an optional sorting unit 10, which is used to sort the loaded conveying containers 3, i.e. to change the order of the conveying containers 3 in the stream of goods. The sorting unit 10 can have several accumulation conveyors arranged in parallel and/or in series and/or one or more circulation carousels. Additionally or alternatively, the sorting unit 10 can be designed as a matrix sorter.

The conveyor facility 1 has at least one unloading station 11, at which the goods 2 are unloaded from the conveying containers 3. Each sorting unit 10 can have several, in particular three or five, unloading stations 11. In particular, each unloading station 11 connected to the sorting unit 10 can be reached by each circulation carousel of the sorting unit 10. In the unloading station 11, conveying containers 3 loaded with goods 2 are opened and unloaded, in particular automatically.

The conveying containers 3 emptied in the unloading station 11 are returned via a return line 12 in the conveyor facility 1 and, in particular, made available to the loading station 6 as empty pockets for reloading with goods 2. The emptied conveying containers 3 can also be intermediately stored in an empty pocket storage unit not shown. The return line 12 can also be connected in terms of conveying technology to the goods stock 4, the incoming goods zone 5, the goods storage unit 9 and/or the sorting unit 10. Conveying containers 3 that are not emptied at the unloading station 11 can be fed to the goods stock 4, the incoming goods zone 5, the goods storage unit 9 and/or the sorting unit 10 for further use.

The unloading station 11 is connected to at least one packing station 14 in terms of conveying technology by means of a horizontal conveyor 13. At the packing station 14, the goods 2 are packed into an order 15 ready for dispatch. The packing station 14 is connected in terms of conveying technology to an outgoing goods zone 16. The orders 15 with the goods 2 can leave the conveyor facility 1 via the outgoing goods zone 16. Orders 15 from the outgoing goods zone 16 can be transported away by external means of transport 17, in particular transport vehicles, in particular lorries.

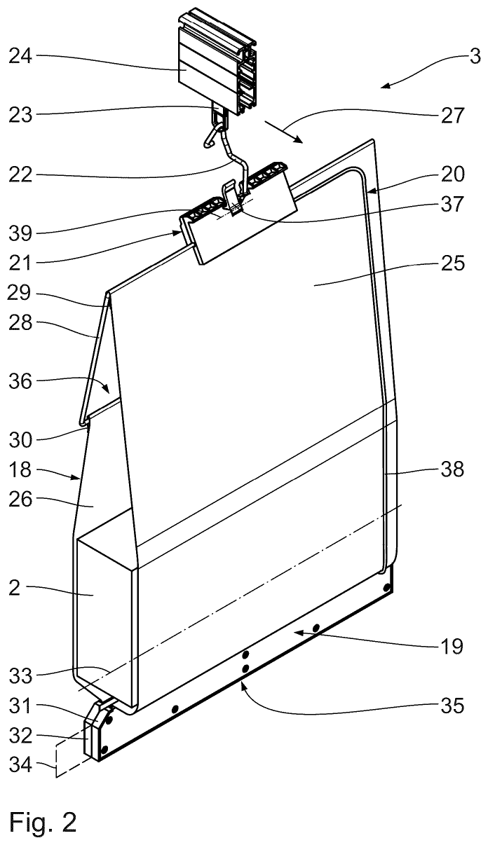

The conveying container 3 is explained in more detail below with reference to FIG. 2.

The conveying container 3 is in particular a transport bag or an overhead conveyor bag. Such overhead conveyor bags are known, for example, from DE 10 2018 201 676 A1, to which express reference is made with regard to the construction and function of the overhead conveyor bags.

The conveying containers 3 have a supporting wall 18, a closing device 19, an actuation device 20 and a suspension device 21.

The suspension device 21 is attached to the supporting wall 18. The suspension device 21 comprises a transport hook 22 for fastening the conveying container 3 to an overhead adapter 23 of a conveyor rail 24. The conveyor rail 24 is part of the overhead conveyor system 8. The overhead adapter 23 is arranged in the conveyor rail 24 so that it can swivel about its roller axes by means of support rollers, which are not shown. In particular, the support rollers also guide the overhead adapter 23 along the conveyor rail 24. The overhead adapter 23 is linearly displaceable along the conveyor rail 24. During the displacement, the overhead adapter 23 can roll on the support rollers. The overhead adapter 23 is also referred to as a roller adapter. By means of a conveyor drive, which is not shown separately, the overhead adapter 23 can be conveyed along the conveyor rail 24 together with the conveying container 3 suspended therefrom.

The supporting wall 18 has a front wall 25 and a rear wall 26. The front wall 25 is arranged at the front of the conveying container 3 along a transport direction 27 and the rear wall 26 is arranged at the rear along the transport direction 27. The front wall 25 is attached to the suspension device 21 via a loading frame 28. For this purpose, the front wall 25 has a frame loop 29 on its upper side. A front side of the loading frame 28 extends through the frame loop 29 of the front wall 25. An upper side of the rear wall 26 is attached to a rear side of the loading frame 28 via a further frame loop 30. The front wall 25 and the rear wall 26 are thus attached to the suspension device 21 via the loading frame 28.

The closing device 19 has a front closing strip 31 and a rear closing strip 32. The closing device 19 has a main extension orientated parallel to a longitudinal axis 33 of the conveying container 3. The closing device 19 projects beyond the supporting wall 18 along the longitudinal axis 33 on both sides. The underside of the front wall 25 is attached to the front closing strip 31. The underside of the rear wall 26 is attached to the rear closing strip 32. The conveying container 3 has a center plane 34 oriented vertically and parallel to the longitudinal axis 33.

According to FIG. 2, the conveying container 3 is shown in a closed state. An underside of the front wall 25 is connected to an underside of the rear wall 26 via the closing device 19. In the closed state, the conveying container 3 is closed at an underside 35. The front closing strip 31 is attached to the rear closing strip 32. The supporting wall 18 limits a load-bearing volume 36 to the front, to the rear and to the bottom. The front closing strip 31 contacts the rear closing strip 32 in the region of the center plane 34. The front wall 25 and the rear wall 26 are made of a textile material and, in particular, are flexible in shape. The goods 2 arranged in the load-bearing volume 36 are located on the underside of the supporting wall 18 due to the force of gravity. The goods 2 are oriented essentially vertically in the load-bearing volume 36. Due to the flexible, in particular bendable, design of the supporting wall 18, the latter assumes a shape corresponding to the shape of the goods 2. The goods 2 are thus held firmly in the load-bearing volume 36.

The closing device 19 has a latch mechanism, not shown in detail, which enables the front closing strip 31 and the rear closing strip 32 to be detachably latched together. The latch mechanism of the closing device 19 can be actuated by means of the actuation device 20. The actuation device 20 comprises an actuation means 37 and a transmission means 38. The actuation device 20 is designed for releasing the connection between the front closing strip 31 and the rear closing strip 32, i.e. for releasing a connection between the front wall 25 and the rear wall 26.

The actuation means 37 is designed as an actuation lever. The actuation means 37 is mounted on the suspension device 21 so as to be rotatable about a lever axis 39 orientated parallel to the longitudinal axis 33.

The actuation means 37 has a mechanical active connection with the transmission means 38, which is designed as a Bowden cable. The transmission means 38 extends from the suspension device 21 to the closing device 19. The transmission means 38 serves to transmit an actuation force from the actuation means 37 to the latch arrangement of the closing device 19.

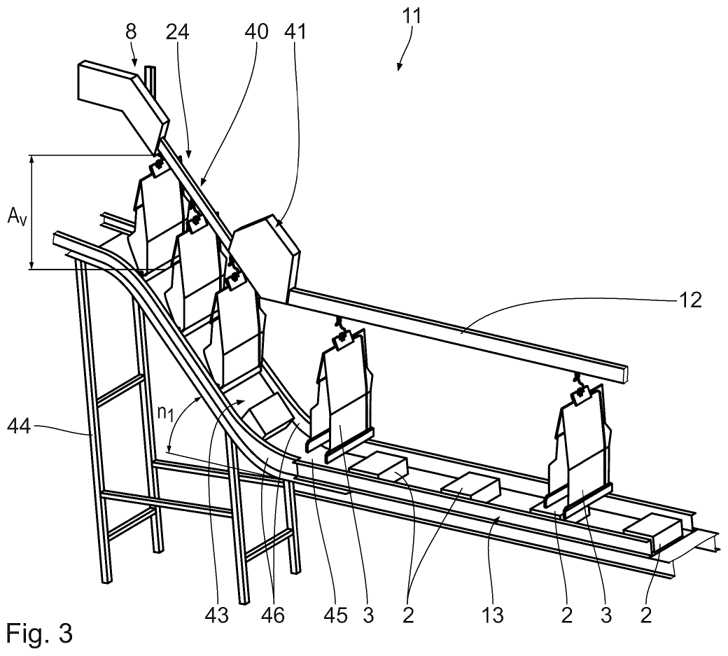

The unloading station 11 is explained in more detail below with reference to FIG. 3.

The unloading station 11 is coupled in terms of conveying technology with the overhead conveyor system 8. By means of the overhead conveyor system 8, conveying containers 3, in particular those loaded with goods 2, are conveyed in a suspended manner along a conveyor rail 24 and fed to the unloading station 11. In the region of the unloading station 11, the conveyor rail 24 has a linear section 40 that slopes downwards relative to the horizontal, i.e. is arranged so as to be inclined downwards.

A switchable opening unit 41 is arranged along the linear section 40 at an opening position. The opening unit 41 has an opening means, not shown in detail, which can co-operate with the actuation means 37 of the conveying container 3. The opening unit 41 is in signal communication with a control unit 42 shown purely schematically in FIG. 1.

The conveyor rail 24 of the overhead conveyor system 8 is adjoined by the return line 12 in the transport direction 27.

A goods discharge surface 43 is arranged below the conveyor rail 24 at the unloading station 11. The goods discharge surface 43 serves to discharge goods 2 from the conveying containers 3. In particular, the goods discharge surface 43 is designed to slope downwards relative to the horizontal at the opening position. At the opening position, the goods discharge surface 43 is configured to be inclined downwards at a first angle of inclination n1 relative to the horizontal. According to the exemplary embodiment shown, the first angle of inclination is 60°.

In dependence on a vertical distance A_{V} from the conveyor rail 24, the goods discharge surface 43, as shown in FIG. 3, can be arranged on a holding frame 44 and placed on the ground. The holding frame 44 is manufactured in particular in the form of a framework and in particular from standardized frame elements. The holding frame is designed to be lightweight and modular. The holding frame 44 is robust and inherently reinforced.

According to the exemplary embodiment shown, the goods discharge surface 43 is designed statically as a sliding surface. The sliding surface has a low coefficient of friction with respect to the goods 2 to be discharged, which is in particular between 0.15 and 0.5. In particular, the sliding surface is made of a material that is low-wear and dimensionally stable, in particular with regard to external temperature and humidity influences. In particular, the material used for the sliding surface has good mechanical damping properties and, in particular, enables good noise damping. The goods discharge surface 43 forms a slide with a robust plastic covering along which the goods 2 discharged from the conveying containers 3 can slide gently downwards. In particular, thermoplastic material, in particular polyethylene and in particular ultra-high molecular weight polyethylene, which is referred to as PE-UHMW or PE-1000, is used as the plastic covering. Other plastic materials, in particular polyamide, are additionally or alternatively possible.

For reasons of stability, the underside of the plastic covering can be supported by a load-bearing material, in particular a steel sheet. It is also possible to design the sliding surface without a plastic covering, i.e. as a steel sheet only.

At its lower end, the goods discharge surface 43 has a transfer section 45, which is horizontally orientated according to the exemplary embodiment shown. At the transfer section 45, the conveying containers 3 are transferred to a horizontal conveyor 13 following in the goods conveying direction 27. The horizontal conveyor 13 conveys the unloaded goods 2 individually to the packing station 14.

A lateral guide 46 is arranged in particular in the region of the goods discharge surface 43. The lateral guide 46 is formed by guiding webs attached to the side of the goods discharge surface 43.

The conveyor rail 24 and the goods discharge surface 43 are arranged parallel to each other along a parallel section, at least in sections. Along the parallel section, the vertical distance A_{V} between the conveyor rail 24 and the goods discharge surface 43 arranged therebelow is constant. In particular, the vertical distance A_{V} is determined in such a manner that the conveying containers 3 conveyed along the conveyor rail 24 rest on their underside 35 on the goods discharge surface 43 or at least touch it. Contact is established in particular by means of the closing strips 31, 32 of the conveying containers 3, in particular by means of the rear closing strip 32.

The operation of the facility 1, in particular the unloading station 11, is explained in more detail below.

Goods 2 are conveyed from the goods stock 4 and/or from the incoming goods zone 5 to the loading station 6, where they are loaded into conveying containers 3. The loaded conveying containers 3 are fed into the overhead conveyor system 8 at the apparatus 7. The loaded conveying containers 3 are stored in the goods storage unit 9 and/or sorted in the sorting unit 10. The loaded conveying containers 3 are conveyed to the unloading station 11 and unloaded there or conveyed further without being unloaded and returned to the conveyor facility 1 by means of the return line 12.

To unload the conveying containers 3, they are opened at the opening position by means of the opening unit 41 by actuating the actuation means 37 and transmitting this actuation force to the closing device 19 by means of the transmission means 38. The front closing strip 31 is decoupled from the rear closing strip 32, so that the front wall 25 is released from the rear wall 26 and the conveying container 3 is opened at its underside 35. In particular, the opening unit 41 is designed to be switchable in such a manner that the opening unit 41 can be actuated in dependence on a control signal transmitted by the control unit 42. In particular, it is possible that not every conveying container 3 is opened and, in particular, conveying containers 3 can also pass through the opening unit 41 unopened.

Due to the fact that the conveying containers 3 touch the goods discharge surface 43 on their underside 35, the goods 2 can be gently discharged from the open conveying containers 3 directly onto the goods discharge surface 43. The discharged goods 2 can slide downwards on the goods discharge surface 43 to the transfer section 45 due to gravity and from there onto the horizontal conveyor 13.

What is claimed is:

1. An unloading station for a conveyor facility, the station comprising:
an overhead conveyor system including
a conveyor rail deviating from the horizontal in an inclined section,
a conveyor drive, and
a plurality of overhead adapters for conveying along the conveyor rail via the conveyor drive;
a plurality of conveying containers, each container of which is conveyable in a suspended manner on one of the overhead adapters and includes an operable opener with which an underside of the conveying container is openable;
an opening unit for opening the conveying container, wherein the opening unit is arranged along the inclined section at an opening position; and
a goods discharge surface arranged below the conveyor rail for discharging goods discharged from the conveying containers, wherein the goods discharge surface slopes downwards relative to the horizontal at the opening position.

2. The unloading station according to claim 1, wherein the goods discharge surface is inclined downwards at the opening position with respect to the horizontal at a first angle of inclination (n₁), wherein n₁≥45°.

3. The unloading station according to claim 1, wherein the goods discharge surface is arranged at a vertical distance (A_{V}) below the conveyor rail such that the conveying containers touch the goods discharge surface in the unopened state.

4. The unloading station according to claim 3, wherein the vertical distance (A_{V}) is constant along a parallel section of the conveyor rail.

5. The unloading station according to claim 1, wherein the goods discharge surface is a sliding surface.

6. The unloading station according to claim 5, wherein the sliding surface has a transfer section which is at least one of arranged to be inclined at a second angle of inclination (n₂) relative to the horizontal, wherein n₂<n₁, or curved at least in sections.

7. The unloading station according to claim 1, wherein the goods discharge surface has a downward conveyor.

8. The unloading station according to claim 7, wherein the downward conveyor is one of a cleated belt and a conveyor belt with at least one of stopping members or an adhesive surface.

9. The unloading station according to claim 7, wherein the downward conveyor has a drive with a variably adjustable conveying speed.

10. The unloading station according to claim 1, wherein the opening unit is switchable such that in response to a control signal the opening unit one of opens a conveying container arranged at the opening position and allows it to pass unopened.

11. The unloading station according to claim 1, wherein a side guide for the conveying containers is arranged at the goods discharge surface.

12. The unloading station according to claim 1, wherein the inclined section slopes downwards in relation to the horizontal.

13. A conveyor facility comprising an unloading station according to claim 1 and a horizontal conveyor.

14. The conveyor facility according to claim 13, wherein the horizontal conveyor adjoins the goods discharge surface.

15. A method for the automated unloading of conveying containers in a conveyor facility, the method comprising:
conveying the conveying containers via overhead adapters along a conveyor rail that slopes downwards at least in sections relative to the horizontal;
opening at least one conveying container of the conveying containers at an opening position via an opening unit; and
gravity-induced discharging of goods from the conveying containers onto a goods discharge surface arranged below the conveyor rail, wherein the goods discharge surface slopes downwards relative to the horizontal at the opening position.

16. The method according to claim 15, wherein the conveying containers are guided to abut against the goods discharge surface upstream of the opening position.

17. The method according to claim 15, wherein the conveying containers are opened in dependence on the conveyed goods.
